(19) United States
(12) Patent Application Publication
(10) Pub. No.: US 2003/0213671 A1
(43) Pub. Date: Nov. 20, 2003

(54) Lube free clutch sleeve

(76) Inventors: David R. DePiazza, Aberden, NC (US); Ronald B. Morford, Southern Pines, NC (US)

Correspondence Address: CARLSON, GASKEY & OLDS, P.C., 400 WEST MAPLE ROAD, SUITE 350, BIRMINGHAM, MI, 48009, US

(21) Appl. No.: 10/150,614

(22) Filed: May 17, 2002

(51) Int. Cl. F16D 23/14

(52) U.S. Cl. 192/98; 192/113.5

(57) ABSTRACT

A bearing release assembly includes a release bearing housing actuated by a release fork to move axially along a rotating shaft. The release bearing housing moves a release sleeve axially along the rotating shaft to disengage clutch levers in response to pivotal movement of a release fork. The release sleeve includes an oil-impregnated powdered metal insert in sliding contact with the rotating shaft. The oil-impregnated powdered metal insert is self-lubricating to eliminate the need for periodic maintenance and lubrication of the release sleeve simplifying operation and maintenance of a clutch assembly.

### BACKGROUND OF THE INVENTION

This invention relates generally to a release bearing assembly for a clutch assembly and more particularly to a release sleeve for use in the release bearing assembly.

Typically, a common pull-type clutch is disengaged by pivoting a clutch release fork by actuating a clutch pedal. The clutch release fork moves a release sleeve along a driven shaft between engaged and disengaged positions of a clutch disk. The release sleeve moves along the rotating input shaft transferring pivoting clutch fork motion to the rotating clutch disk assembly. Because the release sleeve is in constant contact with the rotating input shaft, it must resist a great amount of frictional wear. The release sleeve is therefore commonly fabricated from a high tensile steel material. However, the weight of the steel release sleeve adds resistance to actuation of the clutch release assembly.

An improvement on steel release sleeves is a composite sleeve fabricated from a polymer material having a metallic bushing disposed on its contact surface with the rotating shaft. The metallic bushing installed within the polymer sleeve is typically comprised of a metallic material such as bronze that requires periodic lubrication. Without sufficient lubrication friction between the release sleeve and the rotating shaft creates heat build-up and wear. Such composite release sleeves operate satisfactorily in applications where lubrication is easily accomplished during routine maintenance. However, in some applications routine maintenance to ensure proper lubrication between the shaft and the release sleeve is difficult and time consuming.

It is also known in the art to provide a release sleeve comprised of a Teflon impregnated material in contact with the rotating shaft to provide dry lubrication between the release sleeve and the shaft. In many applications, such dry lubrication is satisfactory for preventing excessive heat build-up and the resulting undesirable friction. However, in some applications, it is desirable to maintain a wet type of lubrication between the shaft and release bearing.

Release sleeves fabricated from Teflon impregnated materials are typically formed in a molding process where the sleeve is fabricated by injecting plastic at a high temperature into a mold. The plastic then solidifies as it cools providing the desired shape. Release sleeves fabricated in a molding processes are subject to dimensional changes during cooling. The tolerances required for a release sleeve must be sufficiently tight to provide a sleeve that is consistent with the operation of the clutch assembly. Further, molded parts often exhibit out-of-round properties in the finished part. The finished molded parts are often not sufficiently circular within the tight tolerances required for use within a clutch assembly.

Accordingly, it is desirable to design and fabricate a release sleeve requiring little periodic maintenance while still providing the required lubrication to prevent heat build-up and wear between the bearing and the shaft.

### SUMMARY OF THE INVENTION

An embodiment of this invention is a release sleeve comprised of an outer polymer sleeve and an oil-impregnated powdered metal insert disposed within the release sleeve and in contact with the rotating shaft.

The release sleeve includes an outer sleeve formed from a polymer defining inner and outer surfaces. An oil-impregnated powdered metal insert disposed within the outer sleeve includes an outer surface in contact with the inner surface of the outer sleeve and an inner surface in contact with the rotating shaft.

The oil-impregnated powdered metal insert includes a length substantially the same as that on the outer sleeve such that the entire inner surface of the combined release sleeve provides for self-lubrication between the release bearing and the rotating shaft.

In another embodiment of this invention the oil-impregnated powdered metal sleeve is positioned only on a portion of the length of the release sleeve to provide the favorable lubricating properties on only a portion of the release sleeve that is in contact with the rotating shaft. The release sleeve includes an outwardly extending flange. An oil-impregnated powdered metal sleeve increases the strength of the release sleeve that is favorable for specific applications involving particularly high stresses and high loads and is easily fabricated within strict tolerance required for clutch assembly applications.

Accordingly, the release sleeve of this invention provides for lubrication between the shaft and the release sleeve reducing friction without the need for periodic lubrication of the clutch release bearing assembly.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a cross-sectional view of a clutch assembly;

FIG. 2 is a cross-sectional view of the release sleeve for the clutch assembly; and

FIG. 3 is another embodiment of a release sleeve for a clutch assembly.

### DETAILED DESCRIPTION OF THE PREFERRED EMBODIMENT

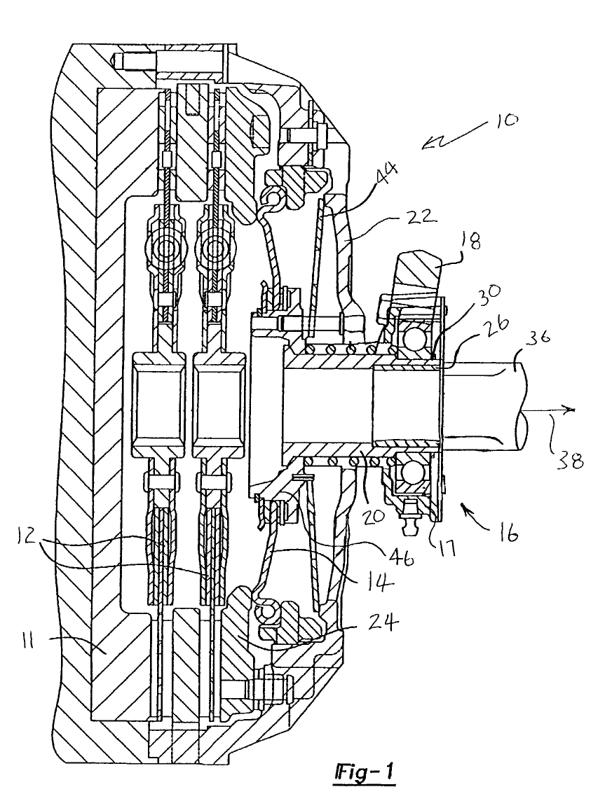

An embodiment of this invention is a clutch assembly shown in FIG. 1 and generally indicated at 10. The clutch assembly 10 includes a pair of friction disks 12 sandwiched between pressure plates 24 movable along the axis 38. Clutch levers 14 are engaged by a clutch retainer 46, which is in turn actuated by a release sleeve 20. The clutch retainer 46 is biased toward a flywheel 11 by diaphragm spring 44. The biasing force exerted by the diaphragm spring 44 forces the pressure plates 24 to sandwich the friction disks 12 against the flywheel 11. Sandwiching the friction disks 12 against the flywheel 11 transmits rotational torque from the flywheel 11 to the shaft 36. The friction disks 12 are disengaged from the clutch 11 by actuation of a release fork 18. The release fork 18 moves the bearing assembly 16 along the shaft 36. Axial movement of the bearing assembly 16 and release bearing housing 17 moves the release sleeve 20 that in turn moves the clutch retainer 46 and the levers 14 to engage or disengage the clutch disk 12.

The release sleeve 20 is installed in a release bearing assembly 16 and actuated by a clutch fork 18 actuated by a vehicle clutch pedal (not shown). The release sleeve 20 is slidably supported in direct contact with the shaft 36. The release sleeve 20 moves axially along the rotating input shaft 36 to transfer clutch fork 18 motion axially to disengage the rotating clutch discs 12. The clutch fork 18 pivots against the release bearing assembly 16 to slide the release sleeve 20 along the input shaft 36. The release sleeve 20 pulls against the clutch retainer 46 to disengage the clutch levers 14. The clutch levers 14 move away from the pressure plate 24 to disengage the clutch disks 12 from the flywheel 11. Release of the clutch fork 18 causes the diaphragm spring 24 to bias the clutch release assembly 16 toward the flywheel 11 into an engaged position.

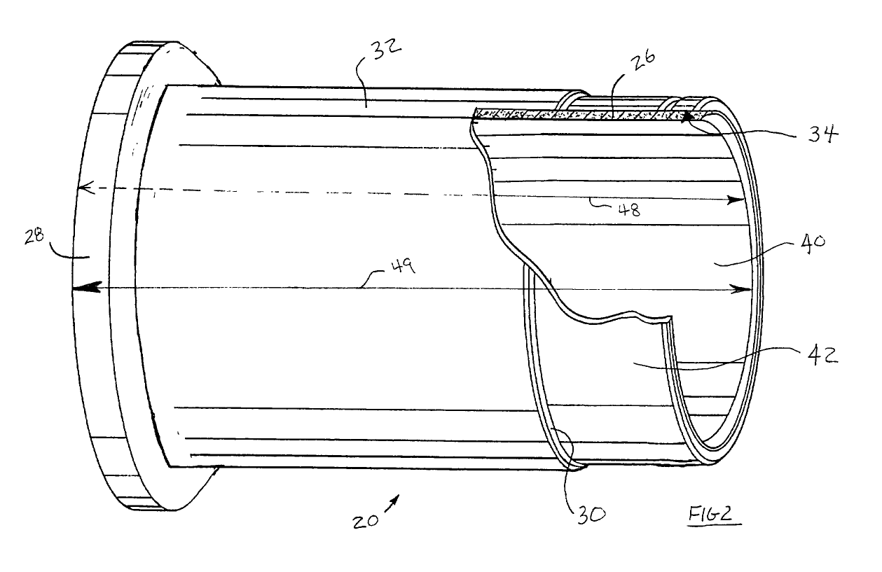

Referring to FIG. 2, the release sleeve 20 includes an outer sleeve 30. Preferably, the outer sleeve 30 comprises a polymer material. The outer sleeve 30 includes an outer surface 32 corresponding to an inner bore of the release bearing housing 17 (FIG. 1). The outer sleeve 30 also includes an inner surface 34 in contact with an outer surface 42 of an oil-impregnated powdered metal sleeve 26. The powdered metal sleeve 26 also includes an inner surface 40 in contact with the rotating shaft 38. The powdered metal sleeve 26 is impregnated with a quantity of oil for self-lubrication. The self-lubricating property of the oil-impregnated powdered metal sleeve 26 substantially reduces the need to periodically lubricate the release sleeve 20.

The oil-impregnated powdered metal sleeve 26 includes length 48 that extends the length 49 of the release sleeve 20 to provide the bearing surface between the release sleeve 20 and the rotating shaft 38. The release sleeve 20 includes a flange 28 that contacts the clutch retainer 46 to actuate the clutch lever 14.

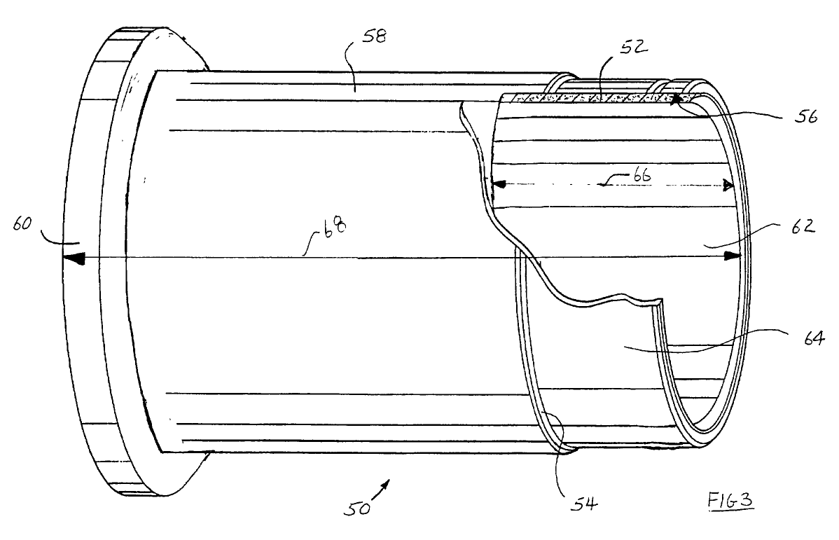

Referring to FIG. 3, another embodiment of the clutch release sleeve is generally indicated at 50 and includes an oil-impregnated powdered metal insert 52 disposed within an outer sleeve 54. The outer sleeve 54 includes an outer surface 58 that cooperates with the release bearing housing 17. A flange 60 engages the clutch retainer 46 to transfer axial movement of the bearing assembly 16 to the clutch levers 14 (FIG. 1). The outer sleeve 54 also includes an inner surface 56 that is in contact with an outer surface 64 of the oil-impregnated powdered metal sleeve 52. The oil-impregnated powdered metal sleeve 52 also includes an interior surface 62 that faces the shaft 38 of the clutch assembly 10.

The oil-impregnated powdered metal sleeve 52 includes a length 66 that is less than the length 68 of the outer sleeve 54. The oil-impregnated powdered metal sleeve 52 is provided only in the bearing area in which the release sleeve 50 would be in contact with the rotating shaft 38 of the clutch assembly 10.

Referring to FIGS. 2 and 3, the oil-impregnated powdered metal sleeve 26, 52 may be installed within the outer sleeve 30,54 in any way known to a worker skilled in the art. Preferably, the oil-impregnated powdered metal sleeve 26, 52 is integrally molded with the outer sleeve 30, 54 to form a composite structure. Installation of the powdered metal sleeve 26, 52 may be accomplished in an insert molding process as is known to a worker skilled in the art.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. It is understood that within the scope of the appended claims, the invention may be practiced otherwise than as specifically described. For that reason the following claims should be studied to determine the true scope and content of this invention.

What is claimed is:

1. A clutch assembly comprising;
a bearing assembly defining a bore;
a clutch release sleeve having an outer surface facing said bore and an inner surface facing a shaft; and
an oil impregnated powdered metal sleeve having an outer surface facing said inner surface of said release sleeve and an inner surface facing said shaft.

2. The assembly of claim 1, further including a clutch release fork engaged to move said bearing assembly along said shaft between engaged and disengaged positions.

3. The assembly of claim 2, wherein said release sleeve is fabricated from a polymer material.

4. The assembly of claim 2, wherein said release sleeve is fabricated from a metallic material.

5. The assembly of claim 3, wherein said oil impregnated powder metal sleeve is insert molded into said release sleeve.

6. The assembly of claim 1, wherein said release sleeve and said oil impregnated powdered metal sleeve are of a common length.

7. The assembly of claim 1, wherein said oil impregnated powdered metal sleeve includes a length less than a length of said release sleeve.

8. The assembly of claim 1, wherein said release sleeve includes a flange portion extending outward of from said release sleeve.

9. The assembly of claim 1, wherein said oil impregnated powdered metal sleeve includes an inner diameter sized to provide a running fit along said shaft.

10. The assembly of claim 1, wherein said oil impregnated powdered metal sleeve is positioned on one end of said release sleeve.

11. A clutch release sleeve assembly comprising;
an outer sleeve including outer and inner surfaces; and
an oil impregnated powdered metal sleeve disposed within said outer sleeve and including an inner surface for sliding contact with a rotating shaft.

12. The assembly of claim 11, wherein said outer sleeve is fabricated from a polymer material.

13. The assembly of claim 12, wherein said oil impregnated powder metal sleeve is insert molded into said release sleeve.

14. The assembly of claim 11, wherein said release sleeve is fabricated from a metallic material.

15. The assembly of claim 11, wherein said oil impregnated powdered metal sleeve includes a length less than a length of said release sleeve.

16. The assembly of claim 11, wherein said outer sleeve includes a flange portion.
